(19) United States
(12) Patent Application Publication
(10) Pub. No.: US 2004/0107279 A1
(43) Pub. Date: Jun. 3, 2004

(54) Network system

(75) Inventor: Sunao Kawai, Toyoake-shi (JP)

Correspondence Address: OLIFF & BERRIDGE, P. O. BOX 19928, ALEXANDRIA, VA, 22320, US

(73) Assignee: BROTHER KOGYO KABUSHIKI KAISHA, Nagoya-shi (JP)

(21) Appl. No.: 10/720,375

(22) Filed: Nov. 25, 2003

(30) Foreign Application Priority Data
Nov. 25, 2002 (JP) 2002-341115

(51) Int. Cl. G06F 15/173; G06F 15/177

(52) U.S. Cl. 709/224; 709/221

(57) ABSTRACT

In a network system, the function of an electronic device is shared by a plurality of terminal device, which are communicatively connected through a network. Operational parameters of the electronic device can be set by users of the plurality of terminal devices through the network. The network system includes a monitoring time determining system that determines a monitoring time with respect operational parameters set by a first user, a monitoring system that monitors whether a request for modification of the operational parameters issued by a second user is received during the monitoring period, and a modification control system that modifies the operational parameters in accordance with the request for modification if the monitoring system determines that the request for the modification is received after expiration of the monitoring period, the modification control system executes a predetermined operation if the request for modification is received during the monitoring period.

### BACKGROUND OF THE INVENTION

The present invention relates to a network system in which operational parameters of a target electronic device can be set/modified using another electronic device, which is connected to the target electronic device through a network.

Conventionally, a network system having a printer and personal computers communicably connected with each other through a network has been known. As an example of such a network system, a system in which the operational parameters of the printer can be set and/or modified by each personal computer through the network and the printer operates in accordance with the thus set/modified operational parameters is known. An example of such a network system is disclosed In Japanese Patent Application Provisional Publication No. HEI 11-23087.

In the above described conventional network system, there is a problem as indicated below.

When a plurality of users share the function of the printer, the users may intend to use the printer with different settings of the operational parameters. For example, after a first user modified the functional parameters, a second user may modify the operational parameters before the first user uses the printer with the operational parameters modified by the first user. In such a case, when the first user uses the printer without knowing the operational parameters have been modified by the second user, the printer may not operate as intended by the first user. Alternatively, due to such potential problems, the second user may feel uneasy whether he/she may modify the operational parameters.

To avoid the above problem, the network system may be configured such that the first user can apply a protection to the operational parameters so as not to be modified by another (second) user. However, in such a system, if the first user applies the protection to the operational parameters, and thereafter, forgets to release the protection, the other users cannot modify the operational parameters.

### SUMMARY OF THE INVENTION

The present invention is advantageous in that an improved network system is provided, in which operational parameters set by a first user may not be modified easily by a second user, but is free from the problem described above.

According to an aspect of the invention, there is provided a network system having a plurality of terminal devices and an electronic device whose function is shared by the plurality of terminal device, the plurality of terminal devices and the electronic device being communicatively connected through a network, operational parameters of the electronic device being set by users of the plurality of terminal devices through the network. The network system includes a monitoring period determining system that determines a monitoring period with respect to operational parameters set by a first user, a monitoring system that monitors whether a request for modification of the operational parameters issued by a second user is received during the monitoring period, and a modification control system that modifies the operational parameters in accordance with the request for modification if the monitoring system determines that the request for the modification is received after expiration of the monitoring period, the modification control system executing at least one of rejecting the request by the second user and outputting a message corresponding to the request by the second user if the monitoring system determines that the request for modification is received during the monitoring period.

Optionally, the monitoring period may be defined as a time period after the operational parameters are set by the first user.

Alternatively, the monitoring period setting system may include a time period inputting system. In this case, the monitoring period is determined based on the time period input through the time period Inputting system.

Further alternatively, an end of the monitoring period is defined as a point of time.

Furthermore, the monitoring period setting system may include a time Inputting system. In this case, an end of the monitoring period is determined based on the point of time which is input through the time inputting system.

Still optionally, the message output by the modification control system may be a message, which is transmitted to the second user, indicating that a current time is within the monitoring period.

Further optionally, the message output by the modification control system may be a message, which is transmitted to the first user, informing that the operational parameters have been modified by the second user within the monitoring period.

According to another aspect of the invention, there is provided a network system having a plurality of terminal devices and an electronic device whose function is shared by the plurality of terminal device, the plurality of terminal devices and the electronic device being communicatively connected through a network, operational parameters of the electronic device being set by users of the plurality of terminal devices through the network. The network system may include a number of execution determining system that determines the number of times of operations to be executed by the electronic device in accordance with operational parameters set by a first user, a monitoring system that monitors whether the number of executed operations of the electronic device exceeds the number of times determined by the number of execution determining system when a request for modification of the operational parameters issued by a second user is received, and a modification control system that modifies the operational parameters in accordance with the request for modification if monitoring system determines that the number of executed operations of the electronic device exceeds the number of times determined by the number of execution determining system, the modification control system executing at least one of rejecting the request by the second user and outputting a message corresponding to the request by the second user if the monitoring system determines that the number of executed operations of the electronic device is equal to or less than the number of times determined by the number of execution determining system.

Optionally, in the network system, the terminal device includes a instruction system that instructs the electronic device to execute a job and the electronic device includes a job executing system that executes the job instructed by the terminal device. The number of execution determining system determines the number of executions of the job to be executed by the job executing system.

Optionally, the message output by the modification control system may be a message, which is transmitted to the second user, indicating that the number of executed operations of the electronic device is equal to or less than the number of times determined by the number of execution determining system.

Further optionally, the message output by the modification control system may be a message, which is transmitted to the first user, informing that the operational parameters have been modified by the second user before the number of executed operations of the electronic device exceeds the number of times determined by the number of execution determining system.

Each of the network systems above may be provided with a permission requesting system that requests the first user for permission to modify the operational parameters.

Optionally, the network system may include an effective period determining system that determines whether an effective period designated by the terminal device has expired, and a recovering system that sets the operational parameters to previously set values after expiration of the effective period.

Further optionally, the network system may include a postponed period checking system that checks whether a postponed period for postponing the modification of the operational parameters has expired, the postponed period being instructed by the terminal device, the modification controlling system enabling the modification of the operational parameters after expiration of the postponed period.

Further more, the network system may include a setting management device which is connected with the terminal device and a plurality of electronic devices through the network, the setting management device being provided with a setting input system that is used to input modification settings of the operational parameters for the plurality of electronic device, the modification settings input through the setting input system being set in the plurality of electronic devices.

In this case, one of the plurality of terminal devices may include the setting management device.

Optionally, the setting management device includes an electronic device selecting system that selects at least one of the plurality of electronic devices as a target device whose operational parameters are to be modified, the modification settings input through the setting input system being effected as the modification settings for the at least one of the electronic device selected by the electronic device selecting system.

Further optionally, the terminal device may include an instruction system that transmits instructions to the electronic device using a predetermined communication protocol and the electronic device may include a job executing system that executes a job which is instructed by the instruction system and transmitted from the terminal device using the predetermined communication protocol. The operational parameters may include a parameter to be used when the electronic device communicates with the terminal device using the predetermined communication protocol.

Still optionally, the electronic device may include a printing system, the operational parameters including a parameter related to an output format when the electronic device executes a print job with the printing system.

In this case, the parameter related to the output format may include a parameter related to a banner print.

Optionally, the electronic device may include a printing system, the operational parameters including a parameter related to a sheet supply when the electronic device prints a print job with the printing system.

In this case, the printing system may be configured to be capable of using a plurality of types of sheets for printing, the parameter related to the sheet supply including a default type of a sheet to be used.

Alternatively, the printing system may include a plurality of sheet trays containing sheets to be used for printing, the parameter related to the sheet supply including a default tray to be used.

Optionally, the electronic device may include an interruption procedure execution system that executes an interruption procedure when a predetermined job is executed, the operational parameters including a parameter that enables/disables execution of the interruption procedure during the predetermined job.

According to a further aspect of the invention, there is provided a network system having a plurality of terminal devices and an electronic device whose function is shared by the plurality of terminal device, the plurality of terminal devices and the electronic device being communicatively connected through a network, operational parameters of the electronic device being set by the plurality of terminal devices through the network. The network system may include a modifying system that modifies the operational parameters in accordance with a request for modification of the operational parameters requested by a terminal device, a message storing system that stores a message input by a user of the terminal device with which the operational parameters are modified in relationship with modified operational parameters, and a message outputting system that outputs the message stored in relationship with the modified operational parameters by the message storing system in response to an output command of a message corresponding to the modified operational parameters.

According to another aspect of the invention, there is provided an electronic device for a network system having a plurality of terminal devices, a function of the electronic device being shared by the plurality of terminal device, the plurality of terminal devices and the electronic device being communicatively connected through a network, operational parameters of the electronic device being set by users of the plurality of terminal devices through the network. The electronic device may be provided with a monitoring time determining system that determines a monitoring time with respect operational parameters set by a first user, a monitoring system that monitors whether a request for modification of the operational parameters issued by a second user is received during the monitoring period, and a modification control system that modifies the operational parameters in accordance with the request for modification if the monitoring system determines that the request for the modification is received after expiration of the monitoring period, the modification control system executing at least one of rejecting the request by the second user and outputting a message corresponding to the request by the second user if the monitoring system determines that the request for modification is received during the monitoring period.

According to a furthermore aspect of the invention, there is provided an electronic device for a network system having a plurality of terminal devices, a function of the electronic device being shared by the plurality of terminal device, the plurality of terminal devices and the electronic device being communicatively connected through a network, operational parameters of the electronic device being set by users of the plurality of terminal devices through the network. The electronic device may be provided with a number of execution determining system that determines the number of times of operations to be executed by the electronic device in accordance with operational parameters set by a first user, a monitoring system that monitors whether the number of executed operations of the electronic device exceeds the number of times determined by the number of execution determining system when a request for modification of the operational parameters issued by a second user is received, and a modification control system that modifies the operational parameters in accordance with the request for modification if monitoring system determines that the number of executed operations of the electronic device exceeds the number of times determined by the number of execution determining system, the modification control system executing at least one of rejecting the request by the second user and outputting a message corresponding to the request by the second user if the monitoring system determines that the number of executed operations of the electronic device is equal to or less than the number of times determined by the number of execution determining system.

According to yet another aspect of the invention, there is provided an electronic device for a network system having a plurality of terminal devices, a function of the electronic device being shared by the plurality of terminal device, the plurality of terminal devices and the electronic device being communicatively connected through a network, operational parameters of the electronic device being set by the plurality of terminal devices through the network. The electronic device may include a modifying system that modifies the operational parameters in accordance with a request for modification of the operational parameters requested by a terminal device, a message storing system that stores a message input by a user of the terminal device, with which the operational parameters are modified, in relationship with the modified operational parameters, and a message outputting system that outputs the message stored in relationship with the modified operational parameters by the message storing system in response to an output command of a message corresponding to the modified operational parameters.

According to another aspect of the invention, there is provided a computer program product which controls a computer to function as an electronic device for a network system having a plurality of terminal devices, a function of the electronic device being shared by the plurality of terminal device, the plurality of terminal devices and the electronic device being communicatively connected through a network, operational parameters of the electronic device being set by users of the plurality of terminal devices through the network, the computer program product controlling the computer to have functions of a monitoring time determining system that determines a monitoring time with respect operational parameters set by a first user, a monitoring system that monitors whether a request for modification of the operational parameters issued by a second user Is received during the monitoring period, and a modification control system that modifies the operational parameters in accordance with the request for modification if the monitoring system determines that the request for the modification is received after expiration of the monitoring period, the modification control system executing at least one of rejecting the request by the second user and outputting a message corresponding to the request by the second user if the monitoring system determines that the request for modification is received during the monitoring period.

According to a further aspect of the invention, there is provided a computer program product which controls a computer to function as an electronic device for a network system having a plurality of terminal devices, a function of the electronic device being shared by the plurality of terminal device, the plurality of terminal devices and the electronic device being communicatively connected through a network, operational parameters of the electronic device being set by users of the plurality of terminal devices through the network, the computer program product controlling the computer to have functions of a number of execution determining system that determines the number of times of operations to be executed by the electronic device In accordance with operational parameters set by a first user, a monitoring system that monitors whether the number of executed operations of the electronic device exceeds the number of times determined by the number of execution determining system when a request for modification of the operational parameters issued by a second user is received, and a modification control system that modifies the operational parameters in accordance with the request for modification if monitoring system determines that the number of executed operations of the electronic device exceeds the number of times determined by the number of execution determining system, the modification control system executing at least one of rejecting the request by the second user and outputting a message corresponding to the request by the second user if the monitoring system determines that the number of executed operations of the electronic device is equal to or less than the number of times determined by the number of execution determining system.

According to a furthermore aspect of the invention, there is provided a computer program product that controls a computer to function as an electronic device for a network system having a plurality of terminal devices, a function of the electronic device being shared by the plurality of terminal device, the plurality of terminal devices and the electronic device being communicatively connected through a network, operational parameters of the electronic device being set by the plurality of terminal devices through the network, the computer program product controlling the computer to have functions of a modifying system that modifies the operational parameters in accordance with a request for modification of the operational parameters requested by a terminal device, a message storing system that stores a message input by a user of the terminal device, with which the operational parameters are modified, in relationship with the modified operational parameters, and a message outputting system that outputs the message stored in relationship with the modified operational parameters by the message storing system in response to an output command of a message corresponding to the modified operational parameters.

According to another aspect of the invention, there is provided a network system having a plurality of terminal devices and an electronic device whose function is shared by the plurality of terminal device, the plurality of terminal devices and the electronic device being communicatively connected through a network, operational parameters of the electronic device being set by users of the plurality of terminal devices through the network. The network system includes a monitoring condition determining system that determines a monitoring condition with respect operational parameters set by a first user, a monitoring system that monitors whether a request for modification of the operational parameters received from a second user meets the monitoring condition, and a modification control system that modifies the operational parameters in accordance with the request for modification if the monitoring system determines that the request for the modification meets the monitoring condition, the modification control system executes a predetermined operation if the monitoring system determines that the request for modification does not meet the monitoring condition.

### BRIEF DESCRIPTION OF THE ACCOMPANYING DRAWINGS

FIG. 1 shows a configuration of a network system according to a first embodiment of the invention;

FIGS. 2A and 2B are block diagrams showing configurations of a personal computer and a printer;

FIG. 3A shows an example of a functional parameter setting window displayed when functional parameters of the printer shown in FIG. 1 are set by a first user;

FIG. 3B shows an example of a protection parameter setting window;

FIG. 3C shows an alternative example of a protection parameter setting window;

FIG. 4 shows an example of a first warning message window which is displayed when a second user attempts to modify the functional parameter during a monitoring period;

FIG. 5A shows an example of a second warning message window which is displayed when the second user attempts to modify the functional parameter during the monitoring period;

FIG. 5B shows an example of an input window for sending a request for modification to the first user;

FIG. 5C shows an example of a period setting window used for inputting a reservation period;

FIG. 6 shows an example of a notification message transmitted to the first user when the modification history data is modified by the second user during the monitoring period;

FIG. 7 shows a data structure of an example of a user management database for managing users using the network system shown in FIG. 1;

FIG. 8 shows an example of the modification history database for managing the parameter settings of the printer;

FIG. 9 shows an example of a reservation database for managing reserved parameter settings;

FIG. 10 shows a flowchart illustrating a first modifying procedure executed in the network system shown in FIG. 1;

FIG. 11 shows a flowchart illustrating a second modifying procedure executed in the network system shown in FIG. 1;

FIG. 12 shows a flowchart illustrating a comment displaying procedure executed in the personal computer;

FIG. 13 is a flowchart illustrating a printing procedure executed in the printer;

FIG. 14 shows a main window of a modification input program which runs on a Web server in a parameter setting system according to a second embodiment;

FIG. 15 is an example of a parameter setting window according to the second embodiment;

FIG. 16 is another example of the parameter setting window according to the second embodiment;

FIG. 17 is a further example of the parameter setting window to be used in the first or second embodiment; and

FIG. 18 is an example of the modification history database corresponding to the parameter setting window shown in FIG. 17.

### DETAILED DESCRIPTION OF THE EMBODIMENT

Hereinafter, a network system according to embodiments of the present invention will be described with reference to the accompanying drawings.

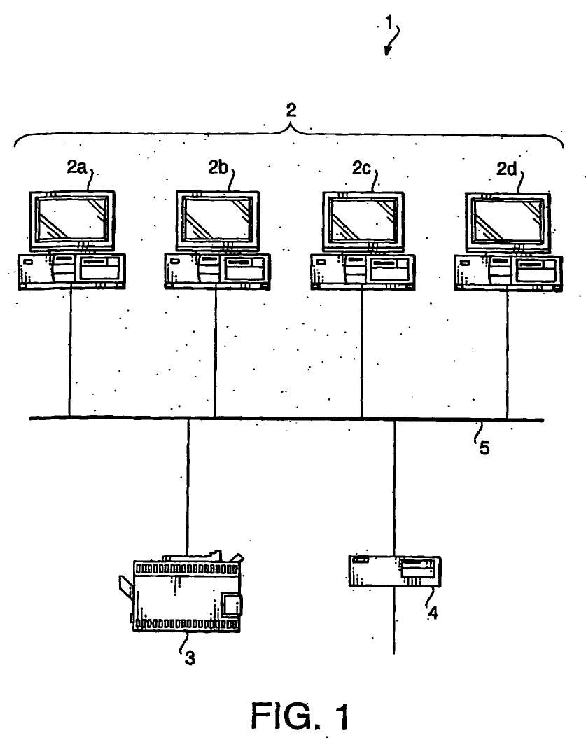

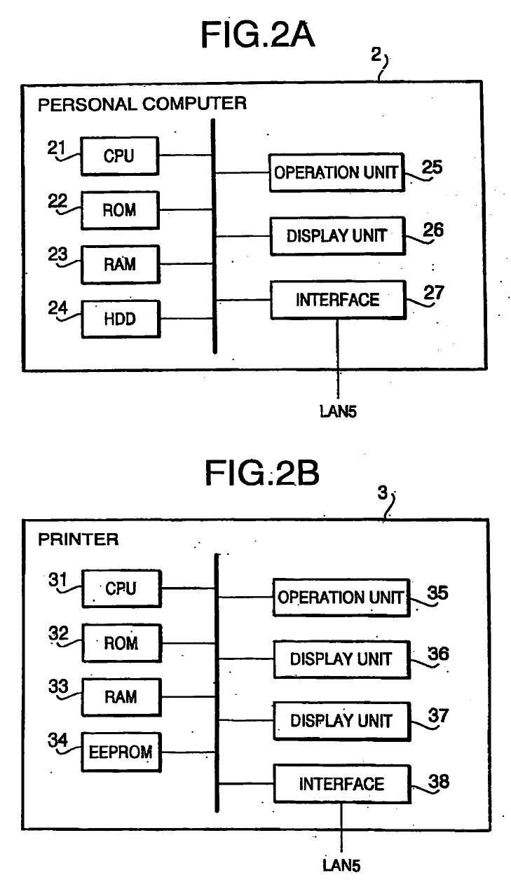

Firstly, a network system 1 according to a first embodiment of the invention will be described with reference to FIGS. 1, 2A and 2B.

FIG. 1 shows a configuration of the network system 1 according to the first embodiment of the invention. The network system 1 according to the embodiment includes, as shown in FIG. 1, personal computers 2 (2a, 2b, 2c, 2d, . . . ), a printer 3 and a router 4. The personal computers 2, the printer 3 and the router 4 are connected with a LAN (Local Area Network) 5. The printer 3 and the personal computers 2 can be communicated with each other through the LAN 5. Further, each of the printer 3 and the personal computers 2 can communicate with external devices through the router 4. The network system 1 is configured such that operating parameters of the printer 3 can be set/modified by any one of the personal computers 2. The printer 3 operates in accordance with the operational parameters as set/modified.

As shown in FIG. 2A, each of the personal computers 2 (2a, 2b, 2c, 2d, . . . ) includes a CPU (Central Processing Unit) 21, a ROM (read only memory) 22, a RAM (Random Access Memory) 23 an HDD (Hard Disk Drive) 24, an operation unit 25, a display unit 26 and an interface 27.

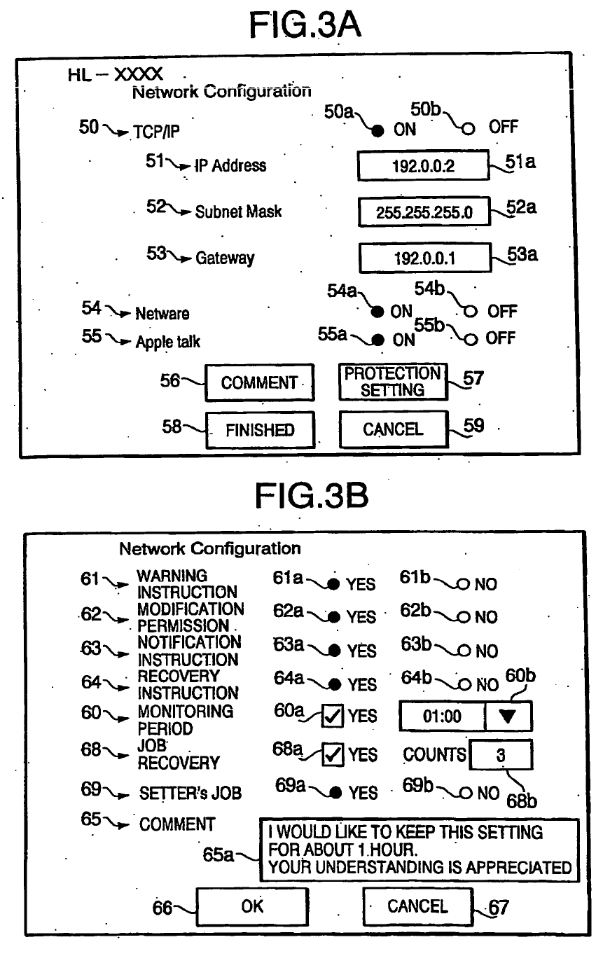

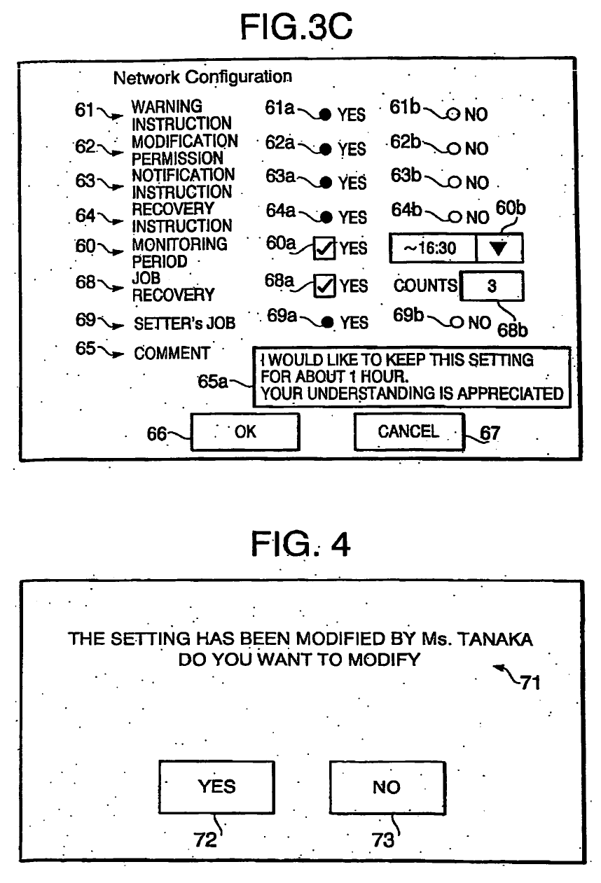

The CPU 21 operates various operational procedures and controls an entire operation of the personal computer 2. According to the embodiment, the CPU 21 retrieves a modification input program for allowing the user to modify the operational parameters, which are reflected in the operation of the printer 3, through a functional parameter setting window shown in FIG. 3A from the ROM 22 and executes the same. The CPU 21 controls the display unit 26 to display various messages in response to requests from the printer 3.

The ROM 22 is a read only memory, which serves as a part of a main memory of the personal computer 2. According to the embodiment, the ROM 22 stores various programs to be executed by the CPU 21, including a system program and the modification input program. The RAM 23 is a readable/writable volatile memory, which also serves as a part of the main memory of the personal computer 2. The RAM 23 provides a work area for temporarily storing intermediate data for data processing. The HDD 24 includes a readable/writable recording medium (i.e., a hard disk) and a reading/writing device thereof.

The operation unit 25 serves as an input device of the personal computer 2. The operation unit 25 typically includes a keyboard provided with a plurality of keys, and a pointing device such as a mouse. The display unit 26 is provided with a display device for displaying various information. The display device may be an LCD (Liquid Crystal Device) panel or a plasma display panel. As is known, the LCD includes a simple matrix type such as an STN type or DSTN type, and an active matrix type such as a TFT type. The interface 27 is for connecting the personal computer 2 to the LAN 5 so that the personal computer 2 can be communicatively connected to an external device which is also connected to the LAN 5.

The printer 3 includes, as shown in FIG. 2B, a CPU 31, a ROM 32, a RAM 33, an EEPROM (Electronically Erasable and Programmable ROM) 34, an operation unit 35, a display unit 36, a printing unit 37 and in interface 38.

The CPU 31 controls the entire operation of the printer 3, and executes various procedures. According to the embodiment, the CPU 31 retrieves a parameter modifying program from the ROM 32 when the printer 3 is powered ON. The parameter modifying program is for modifying operational parameters, which are reflected in the operation of the printer 3, in accordance with the request by the personal computer 2.

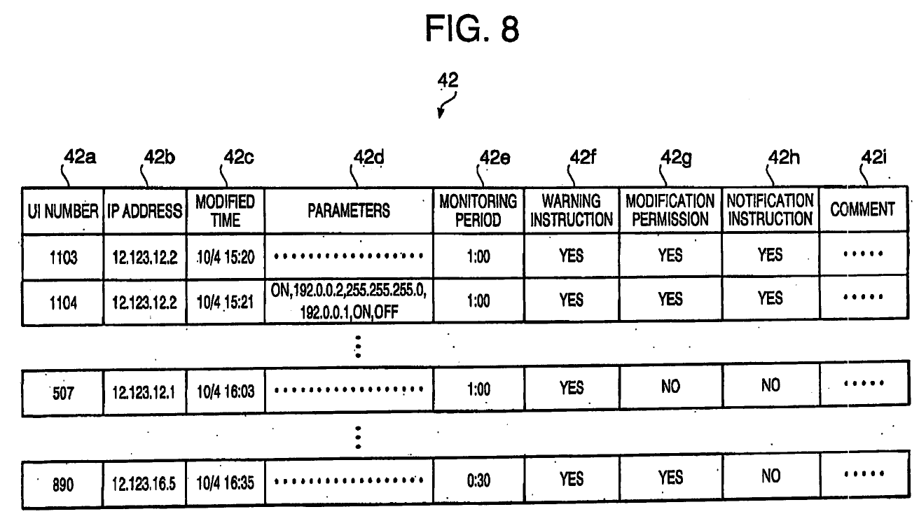

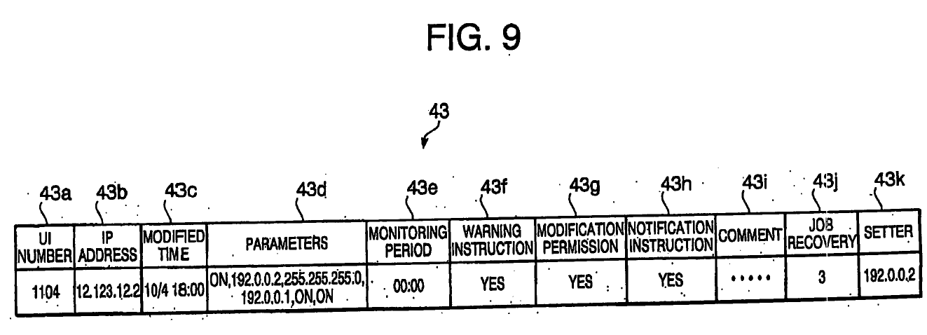

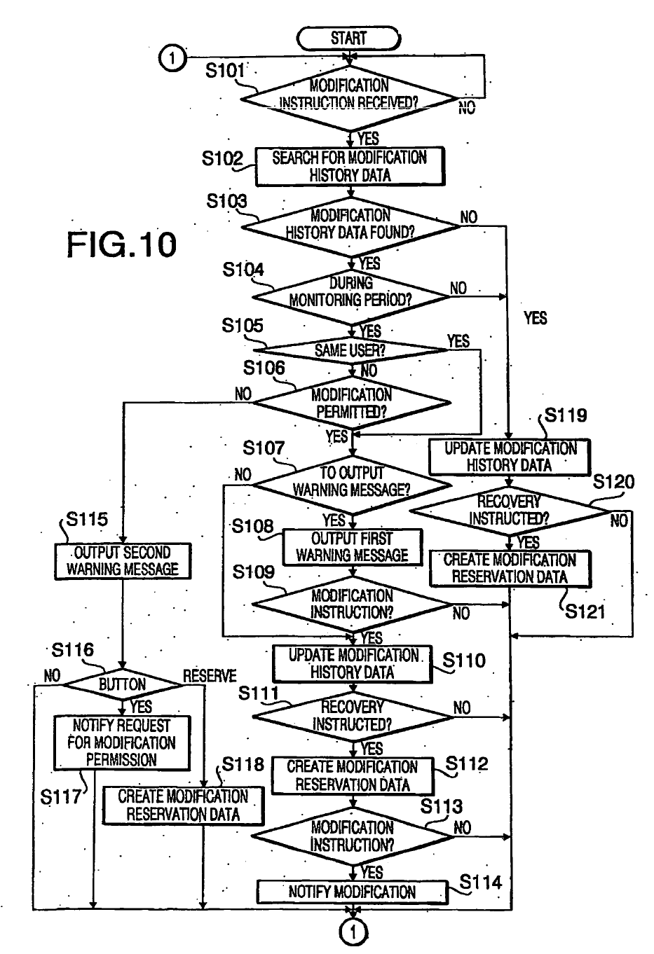

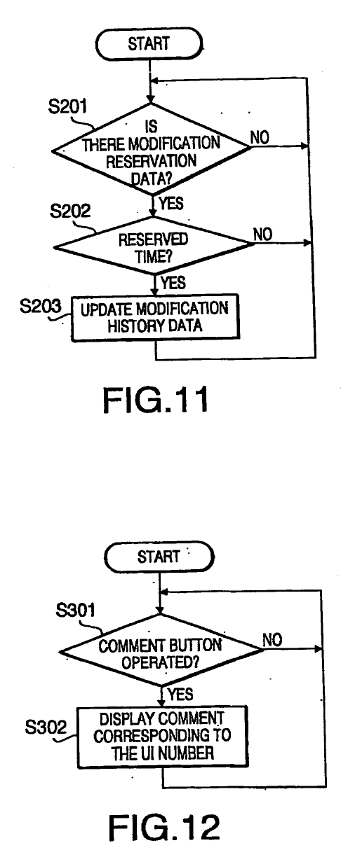

The ROM 32 is a read only memory, which serves as a part of the main memory of the printer 3. The ROM 32 stores various programs including a system program and the parameter modifying program, which will be described later referring to FIGS. 10 and 11. The RAM 33 Is a readable/writable volatile memory, which also serves as a part of the main memory of the printer 3. The RAM 33 provides a work area which temporarily stores intermediate data of data processing. The EEPROM 34 is a readable/writable non-volatile memory, which retains data stored therein even after it is powered OFF. According to the embodiment, the EEPROM 34 stores a management database 41, which will be described later referring to FIG. 7, a modification history database 42, which will be described referring to FIG. 8, and a modification reservation database 43, which will be described referring to FIG. 9.

The operation unit 35 serves as an input device of the printer 3. The operation unit 35 includes a keyboard provided with a plurality of keys, and a touch panel adhered on a screen of the display unit 36. The display unit 36 includes a display device such as the LCD or plasma display panel, and displays various information. The printing unit 37 provides a printing function, with which a monochromatic or color image/characters can be printed. The Interface 38 is for connecting the printer 3 to the LAN 5 so that the printer 3 is communicatively connected with another device such as the personal computer 2 which is also connected to the LAN 5.

Next, parameter setting windows, which enables the user to input operational parameters, which include functional parameters and protection parameters, for the printer 3, will be described referring to FIGS. 3A and 3B.

FIG. 3A shows an example of an operation parameter setting window, which is displayed when the functional parameters of the printer 3 shown in FIG. 1 are input. FIG. 3B shows an example of a protection parameter setting window, which is displayed when the protection parameters are input.

It should be noted that the functional parameter setting window is provided for each UI (user interface) number, and FIG. 3A shows the screen for the UI number of 1104 as an example. It should be noted that each setting of the operational parameters is assigned with the UI number, and various settings of the operational parameters are managed with reference to the UI numbers. By performing a predetermined key operation on the operation unit 25, a user of the personal computer 2 (i.e., 2a, 2b, 2c, 2d, . . . ) can make the display unit 26 to display the functional parameter setting window for a desired UI number.

The functional parameter setting window shown in FIG. 3A includes, as setting parameters, six parameters, which are a TCP/IP 50, an IP Address 51, a Subnet Mask 52, a Gateway 53, a Netware 54 and Apple talk 55. It should be noted that, when the functional parameter setting window is displayed, values stored in the modification history data corresponding to the UI number of the currently displayed functional parameter setting window, which is stored in the modification history database 42 are displayed as the initial values of the contents of the functional parameter setting window.

The setting of the TCP/IP 50 is made by selecting a radio button 50a or 50b. When the user intends to use the TCP/IP, the radio button 50a is selected, while the user does not intend to use the TCP/IP, the radio button 50b is selected. The IP address 51 is set by inputting a value of the IP address in an input box 51a. The setting of the Subnet Mask 52 is made by inputting a value of the Subnet Mask in an input box 52a. The setting of the Gateway 53 is made by inputting a value of the Gateway in an input box 53a. The setting of the Netware 54 is made by selecting a radio button 54a (when necessary) or 54b (when unnecessary). The setting of the Apple talk 55 is made by selecting a radio button 55a (when the Apple talk is to be enabled) or 55b (when disabled).

As shown in FIG. 3A, the functional parameter setting window includes a comment button 56. When the user selects the comment button 56, a comment corresponding to the UI number of the functional parameter setting window displayed on the display unit 26 is retrieved from the modification history database 42 of the printer 3, and displayed on the display unit 26. For example, when the UI number of the functional parameter setting window is 1104, the contents of a comment section 421 of the modification history data, which corresponds to the UI number 1104, of the modification history database 42 is displayed on the display unit 26.

Further, in the functional parameter setting window, there is a protection parameter setting button 57. When the user selects the protection parameter setting button 57, the protection parameter setting window exemplified in FIG. 3B is displayed on the display unit 26.

The functional parameter setting window further includes a “Finished” button 58 and a “Cancel” button 59. When the user selects the “Finished” button 58, a setting modification instruction corresponding to the functional parameter settings as modified are transmitted from the personal computer 2 to the printer 3. The setting modification instruction includes the UI number corresponding to the functional parameter setting window, the value of the IP address of the personal computer 2 with which the parameters are modified parameters (e.g., the TCP/IP 50, IP address 51, Subnet Mask 52, Gateway 53, Netware 54, and the Apple talk 55), and a monitoring period 60 (described later). The setting modification instruction further includes a warning instruction 61, a modification permission 62, a notification instruction 63, a recovery instruction 64 and a comment 65, which will be described later.

In the protection parameter setting window shown in FIG. 3B, there are indicated six protection parameters, which are the warning instruction 61, the modification permission 62, the notification instruction 63, the recovery instruction 64, the monitoring period 60, a job recovery setting 68, a setter's job setting 69 and the comment 65.

The warning instruction 61 is set by selecting a radio button 61a or 61b. When the second user tries to modify the functional parameters during the modification period, a warning message (which will be described later) is displayed on the personal computer 2 operated by the second user if the radio button 61a has been selected by the first user. If the radio button 6ab has been selected by the first user, such a message will not be displayed to the second user.

The modification permission 62 is set by selecting a radio button 62a or 62b. When the first user intends to accept a modification request by the second user during the monitoring period set by the first user, the radio button 62a is to be selected. If the first user intends not to accept the second user's request for modification during the monitoring period, the radio button 62b is to be selected.

The notification instruction 63 is set by selecting a radio button 63a or 63b. If the functional parameters are modified during the modification period by the second user, the fact that the modification was done is notified to the first user when the radio button 63a has been checked. If the radio button 63b has been checked, such a notification will not be made for the first user.

The recovery instruction 64 is made by selecting a radio button 64a or 64b. If the modified parameters are recovered to the setting before they were modified, the radio button 64a is to be selected. If the recovery is unnecessary, the radio button 64b is selected. Thus, when the radio button 64a is selected, the settings made by the second user are effective for the monitoring period or before a predetermined times of executions of printing jobs (which will be described later), and then the settings are recovered to the settings after the monitoring period is elapsed.

The monitoring period 60 becomes available when a check box 60a is checked. The monitoring period is input to an inputting box 60b using a pull down menu. The monitoring period represents a period during which reception of a modification request with respect to the functional parameters (as shown in FIG. 3A) which is received from another user. Hereinafter, the user who previously set the parameters will be referred to as a first user, and the user who modifies the parameters will be referred to as a second user.

In the example shown in FIG. 3A, the monitoring period is input as a period of time. Alternatively, the monitoring period may be set by inputting an end time of the monitoring period as shown in FIG. 3C. In this example, the end time 16:30 is input, at which the monitoring period will end. It should be noted that, when the user (i.e., the first user) intends not to set the monitoring period, be/she can select “No” from the pull down menu.

The job recovery setting 68 is effective when the check box 68a is checked. This setting restricts the modification of the parameter settings until a user-desired number of times of printing jobs have been executed. The user-desired number of times is input in a input box 68b. When the user-desired number of times of printing jobs have been done, the parameter settings are recovered to the previously set ones. As will be described later, when the user-desired number of printing jobs have been executed, even if the monitoring period has not expired, the parameter settings are recovered.

The setter's job setting 69 is for allowing the user to select whether the number of user-desired printing jobs is counted for any user or for the user who made the setting (i.e., the first user). When the number of printing jobs is counted only when the first user used the parameter settings, a radio button 69a is to be selected. When the number of printing jobs is to be counted for any user (i.e,. regardless whether first user or second user), a radio button 69b is selected. It should be noted that the setter's job setting 69 can be set only when the check box 68a of the job recovery setting 68 is selected. Accordingly, it is preferable that the item of the setter is job setting 69 is made gray out when the check box 68a is not checked.

The setting of the comment 65 is done using an input box 65a. That is, the text input in the input box 65a is used as the message corresponding to the modified parameter settings.

It is not preferable if the first user modified the operational parameters and the second user attempted to modify the operational parameter but the modification by the second user was not reflected in the operational parameters and the warning message is not notified to the second user. Therefore, when the radio button 62b is selected for the modification permission 62, it is preferable that the radio button 61a of the warning instruction 61 Is automatically selected (and optionally, the radio button 61b cannot be selected). Then, the second user is notified that his/her modification will not be reflected in the operational parameters.

Next, a message screen which is displayed when the modification request is issued during the monitoring period or before the printing jobs is less than the number of times set in the Input box 68b and the modification is allowed will be described referring to FIG. 4. It should be noted that, in the following description, the term “monitoring period” is used to represent a period of time set in the input box 60b of FIG. 3B or a period that ends at the time set in the input box 60b of FIG. 3C, or during the time when the number of executions of printing jobs is less than the number Input in the input box 68b of FIG. 3B for the sake of brevity of description.

FIG. 4 shows an example of the warning message (which will be referred to as a first warning message) when the modification request is issued within the monitoring period. It should be noted that the first warning message is transmitted from the printer 3 to the personal computer 2 of the second user, and displayed on the display unit 26 of the personal computer 2 of the second user.

As shown in FIG. 4, the first warning message includes a message 71 indicating that the operational parameters have been set/modified and the current time is in the monitoring period (e.g., a message “The parameters have been modified by Ms. TANAKA”) and an inquiry whether the second user intends to modify the parameters (e.g., a message “Do you enter the modifications?”), and a “YES” button 72 and a “NO” button 73. If the second user intends to effect the modification, he/she selects the “YES” button 72, while If the second user does not intend to effect the modification (i.e., the parameters as set by Ms. TANAKA are retained), the “NO” button 73 is selected.

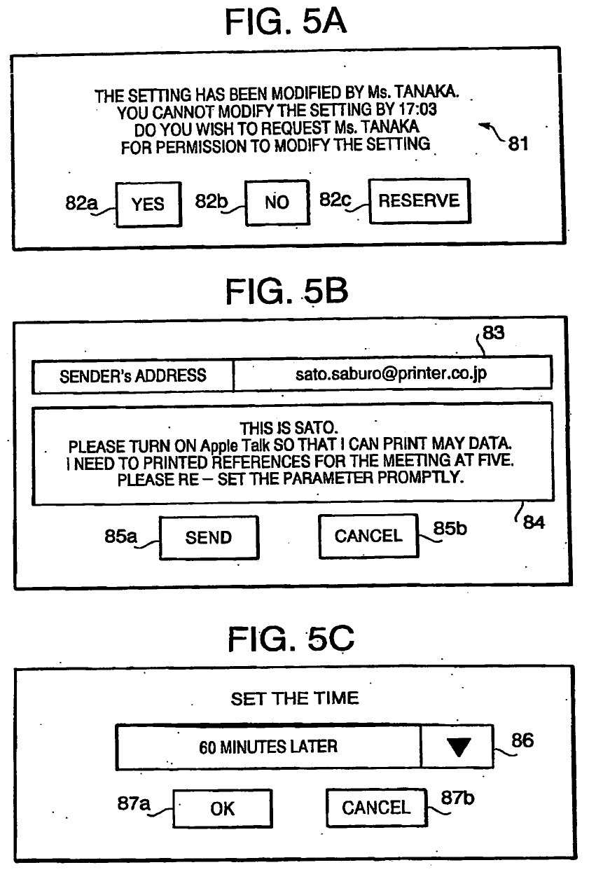

Next, a message window which is displayed when the modification request is issued during the monitoring period (which message will be referred to as a second message) and the permission of the modification is disabled, a modification permission requesting window, and a modification period designating window will be described with reference to FIGS. 5A, 5B and SC.

FIG. 5A shows an example of the second warning message, FIG. 5B shows an example of the modification permission requesting window, and FIG. 5C shows an example of the modification period setting window. It should be noted that the second warning message is transmitted from the printer 3 to the personal computer 2 of the second user and displayed on the display unit of the personal computer 2 of the second user.

The second warning message includes, as exemplified in FIG. 5A, a message 81 which has a message indicating that the parameters have been set/modified and the current time is in the monitoring period (e.g., a message “The parameters have been modified by Ms. TANAKA. You cannot change them by 17:03.”), and an inquiry asking whether a request for modification is to be issued (e.g.. “Do you want to ask Ms. TANAKA for the modification?”), and three selection buttons: a “YES” button 82a; a “NO” button 82b; and a “RESERVE” button 82c. When the user wishes to issue the request for the modification of the parameters, the “YES” button 82a is selected; when the user does not wish to modify the parameters, the “NO” button 82b is selected; and when the user intends to reserve the modification of the parameters, the “RESERVE” button 82c is selected.

When the “YES” button 82a is selected, the selection information is transmitted from the personal computer 2 to the printer 3. Then, from the printer 3, data of the request for modification permission window and an e-mail address of the first user who made the current setting of the operational parameters (which address is obtained based on the user management database 41 and the modification history database 42) are transmitted to the personal computer 2. Then, on the display unit 26 of the personal computer 2, the request for modification window as exemplified in FIG. 5B is displayed on the display unit 26.

In the modification permission requesting window, as exemplified in FIG. 5B, an address input box 83 to which the e-mail address of the second user, who requests for the permission of the modification, is input, a message input box 84 to which a message for requesting the permission of the modification is input, a transmission button 85a and a cancel button 85b are included. When the transmission button 85a is selected, an e-mail message whose contents are the data input in the address input box 83 and the message input box 84 is transmitted with a return address being set to an e-mail address of the first user who has made the current parameter setting. When the cancel button 85b is selected, the window shown in FIG. 5A is displayed.

When the “RESERVE” button 82c is selected, it is notified from the personal computer 2 to the printer 3. Then, form the printer 3, data for the modification period setting window is transmitted to the personal computer 2 of the second user. Then, the modification period setting window, as exemplified in FIG. 5C, is displayed on the display unit 26 of the personal computer 2 of the second user.

As shown in FIG. 5C, the modification period designating period includes a time period input box 86, in which a time period after which the operational parameters are to be modified, is input using a pull-down menu, an “OK” button 87a and a cancel button 87b. The time period input in the time period input box 86 represents an extended period. When the “OK” button 87a is selected, the time period input in the time period input box 86 is transmitted from the personal computer 2 of the second user to the printer 3. When the cancel button 87b is selected, the window shown in FIG. 5A is displayed. It should be noted that the time periods indicated in the pull-down menu are ones, with which the reserved time is after the monitoring period is passed.

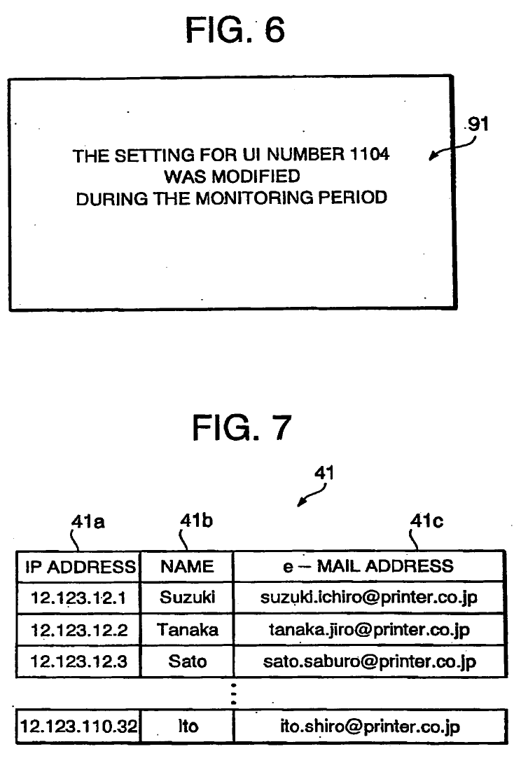

Next, the modification notifying window which is output when the modification request is done during the monitoring period, when the modification is permitted, and when the notification is selected will be described with reference to FIG. 6.

FIG. 6 shows an example of a notification message window. The contents of the notification message window is transmitted to the first user with an e-mall message. When the first user opens the e-mall message, the notification message window is displayed on the display unit 26 of the personal computer 2 of the first user.

As shown in FIG. 6, the notification message window includes a message 91 indicating that the operational parameters are modified within the monitoring period (e.g.. “The parameters of the UI number 1104 have been modified within the monitoring period.”).

Next, the user management database 41 stored in the EEPROM 34 of the printer 3 will be described with reference to FIG. 7. FIG. 7 shows an example of the user management database 41.

As indicated in FIG. 7, the user management database 41 has an IP address section 41a for storing the IP addresses of the personal computers 2 (2a, 2b, 2c, 2d, . . . ) connected to the LAN 5, a name section 41b for storing the user names of the respective personal computers 2, and an e-mail address section 41c for storing the e-mail addresses of the users of the respective personal computers 2.

FIG. 8 shows an example of the modification history database 42 stored in the EEPROM 34.

The modification history database 42 stores modification history data which includes a UI number section 42a, an IP Address section 42b, a modification time section 42c, a setting parameter section 42d, a monitoring period section 42e, a warning instruction section 42f, a modification permission section 42g, a notification instruction section 42h, and the comment section 42i. The contents stored in the modification history database 42 are reflected in the operation of the printer 3.

The UI number section 42a stores the values of the UI numbers, which are unique numbers assigned by the system so that the modification setting windows can be identified thereby.

The IP Address section 42b stores the values of the IP addresses of the personal computers 2 which requested the modification of the operational parameters using the modification setting windows corresponding to the UI numbers of the UI number section 42a.

The modification time section 42c stores times when the modification history data corresponding to the UI numbers in the UI number section 42a are changed.

The setting parameter section 42d stores data corresponding to the functional parameters indicated in the functional parameter setting window exemplified in FIG. 3A. For example, in the functional parameter setting window shown in FIG. 3A (for UI number of 1104), as the functional parameters to be modified, the TCP/IP 50, the IP Address 51, the Subnet Mask 52, the Gateway 53, the Netware 54 and the Apple talk 55 are included. According to the functional parameters shown in the functional parameter setting window, in the setting parameter section 42d, as exemplified in FIG. 8, data of “ON” (setting of the TCP/IP 50), “192.0.0.2” (setting of the IP Address 51), “255.255.255.0” (setting of the Subnet Mask 52), “192.0.0.1.” (setting of the Gateway 53), “ON” (setting of the Netware 54) and “OFF” (setting of the Apple talk 44) are stored.

The monitoring period section 42e, the warning instruction section 42f, the modification permission section 42g, the notification instruction section 42h and the comment section 42i store data respectively corresponding to the monitoring period 60, the warning instruction 61, the modification permission 62, the notification instruction 63 and the comment 65, which are indicated in the protection parameter setting window shown in FIG. 3B.

Next, the modification reservation database 43 stored in the EEPROM 34 of the printer 3 will be described with reference to FIG. 9. FIG. 9 shows an example of the modification reservation database 43. Although the data corresponding to only one UI number is indicated in FIG. 9, in some cases, modification reservation data for a plurality of UI numbers is stored.

The modification reservation database 43 stores the modification reservation data, which includes a UI number section 43a, an IP address section 43b, a reservation time section 43c, a reserved parameter section 43d, a monitoring period section 43e, a warning instruction section 43f, a modification permission section 43g, a notification instruction section 43h, a comment section 43i, a job recovery section 43j and a setter section 43k.

The UI number section 43a stores the values of the UI numbers corresponding to the modification parameter setting window.

The IP address section 43b stores the values of the IP addresses of the personal computers 2 which replace the IP addresses of the IP Address section 42b corresponding to the same UI number at the reservation time which is stored in a reservation time section 43c.

The reservation time section 43c stores times when the modification history data of the modification history database 42 corresponding to the UI numbers in the UI number section 43a is changed.

The reserved parameter section 43d stores data which replaces, at the reserved time stored in the reservation time section 43c, the data stored in the setting parameter section 42d corresponding to the UI number same as the UI number stored in the UI number section 43a. In this example, in the reserved parameter section 43d corresponding to the UI number of 1104 stores, as shown in FIG. 9, data of “ON” (setting of the TCP/IP 50). “192.0.0.2” (setting of the IP Address 51), “255.255.255.0” (setting of the Subnet Mask 52), “192.0.0.1” (setting of the Gateway 53). “ON” (setting of the Netware 54) and “OFF” (setting of the Apple talk 44).

The monitoring period section 43e stores data which replaces the contents of the monitoring period section 42e corresponding to the UI number same as the UI number indicated in the UI number section 43a at the reserved time, which is stored in the reservation time section 43c.

The warning instruction section 43f stores data which replaces the contents of the warning instruction section 42f corresponding to the UI number same as the UI number indicated in the UI number section 43a at the reserved time.

The modification permission section 43g stores data which replaces the contents of the modification permission section 42g corresponding to the UI number same as the UI number indicated in the UI number section 43a at the reserved time.

The notification instruction section 43h stores data which replaces the contents of the notification instruction section 42h corresponding to the UI number same as the UI number indicated in the UI number section 43a at the reserved time.

The comment section 431 stores data which replaces the contents of the comment section 421 corresponding to the UI number same as the UI number indicated in the UI number section 43a at the reserved time.

In the job recovery section 43j, the value set in the input box 68b is stored. The value stored in the job recovery section 43j is decremented by one every time when the printing job is executed. When the value of the number of printing jobs is not set, i.e., when the check box 68a of FIG., 3B not checked, “No” is stored in the job recovery section 43j.

The setter section 43k stores the IP address of the computer the user uses, i.e., the IP address of the computer the first used uses. When the radio button 69a is not selected, the setter section 43k is set to “No”.

Hereinafter, the operational parameter modification procedure of the printer 3 will be described with reference to FIGS. 10 and 11.

FIGS. 10 and 11 show flowcharts illustrating a modifying procedure executed in the network system shown in FIG. 1.

The procedures shown in FIGS. 10 and 11 are executed, for example, when the printer 3 is powered ON and the CPU 31 retrieves the parameter modifying programs from the ROM 32. It should be noted that the procedures shown in FIGS. 10 and 11 are executed simultaneously.

Firstly, the procedure shown in FIG. 10 will be described. In S101, the CPU 31 of the printer 3 determines whether the parameter modification instruction is received. It should be noted that when the “Finished” button 58 is selected in the parameter setting window as shown in FIG. 3A, the parameter modification instruction is transmitted from the personal computer 2 (2a, 2b, 2c, . . . ) on which the “Finished” button 58 is selected. When the CPU 31 determines that the parameter modification instruction is not received (S101: NO), control returns to S101 and the monitoring of the reception of the parameter modification instruction is continued. When the CPU 31 determines that the parameter modification instruction is received (S101: YES), control proceeds to S102. It should be noted that, according to the example described above, the parameter modification instruction includes the IP address of the personal computer 2 which transmitted the parameter modification instruction to the printer 3, the UI number, the operational parameters (i.e., the TCP/IP 50, the IP Address 51, the Subnet Mask 52, the Gateway 53, the Netware 54, the Apple talk 55 when the UI number is 1104), the monitoring period 60, the warning instruction 61, the modification permission 62, the notification instruction 63, the recovery instruction 64 and the comment 65.

When the CPU 31 determines that the parameter modification instruction is received (S101: YES), in S102, the CPU 31 searches for the modification history data (hereinafter, it is occasionally called as the target modification history data) having the UI number, which is identical to that included in the parameter modification instruction, in the modification history database 42. Thereafter, control proceeds to S103.

In S103, the CPU 31 determines whether the target modification history data is in the modification history database 42 based on the search result in step S102. When the CPU 31 determines that the target modification history data is in the modification history database 42 (S103: YES), control proceeds to S104, when the CPU 31 determines that the target modification history data is not in the modification history database 42 (S103: NO), control proceeds to S119.

In S104, the CPU 31 determines whether the present time (the time when the modification is requested) is within a period, which starts from the modification time stored in the modification time section 42c of the target modification history data and ends when the monitoring period stored in the monitoring period section 42e elapses, or the current number of printing jobs is less than the number of printing jobs set in the input box 68b of FIG. 3. When the present time is within the monitoring period or the number of executed printing jobs is less than the value set in the input box 68b (S104. YES), control proceeds to S105. When the present time is not within the monitoring period or the number of printing jobs has become equal to the value set in the input box 68b (S104: NO), control proceeds to S119.

In S105, the CPU 31 determines whether the IP address included in the parameter modification instruction received in S101 is equal to the IP address in the IP Address section 42b of the target modification history data. That is, it is determined whether the modification of the parameters is requested by the same user who made the previous modification. When the CPU 31 determines that the modification of the parameters is requested by the same user (i.e. the first user) who made the previous modification (S105: YES), control proceeds to S119. When it is determined that the modification of the parameters is requested by a different user (i.e., a second user) from the user (i.e., the first user) who made the previous modification (S105: NO), control proceeds to S106.

In S106, the CPU 31 determines whether the modification of the target modification history data is allowed within the monitoring period based on the content of the modification permission section 42g of the target modification history data. When the modification within the monitoring period is allowed (i.e., the content of the modification permission section 42g is “DYES”) (S106: YES), control proceeds to S107. When the modification within the monitoring period is not allowed (i.e., the content of the modification permission section 42g is “NO”) (S106: NO), control proceeds to S115.

In S107, the CPU 31 determines whether the first warning message (see FIG. 4) is to be output based on the content of the warning instruction section 42f of the target modification history data. When it is determined that the first warning message is to be output (i.e., the content of the warning instruction section 42f is “YES”) (S107: YES), control proceeds to S108. When It Is determined that the first warning message is not to be output (i.e., the content of the warning instruction section 42f is “NO”) (S107: NO), control proceeds to S110.

In S108, the CPU 31 controls the printer 3 to transmit the content of the first warning message to the personal computer 2, from which the parameter modification instruction was received in S101 (i.e., the personal computer 2 of the second user). It should be noted that the user name in the first warning message is determined based on the content of the user management database 41 and the content of the IP Address section 42b of the target modification history data. When the personal computer 2 of the second user receives the content of the first warning message, the personal computer 2 displays, under control of the CPU 21, the first warning message on the display unit 26. Then, control proceeds to S109.

In S109, the CPU 31 determines whether the user has instructed to modify the target modification history data stored in the modification history database 42, based on the content of the parameter modification instruction. When it is determined that the user has instructed to modify the target modification history data (i.e., when the “YES” button 72 is selected) (S109: YES), control proceeds to S110. When the user has not made such an instruction (S109: NO), the target modification history data will not be modified, and control returns to S101, where the reception of the parameter modification instruction is monitored. When the “YES” button 72 or the “NO” button 73 is selected, the information of the selected button is transmitted from the personal computer 2 to the printer 3.

In S110, the CPU 31 changes the contents of the IP Address section 42b, the setting parameter section 42d, the monitoring period section 42e, the warning instruction section 42f, the modification permission section 42g, the notification instruction section 42h and the comment section 42i of the target modification history data (i.e., the modification history data whose UI number is the same as the UI number included in the parameter modification instruction) to the set/input contents of the IP Address, the set parameters (e.g., when UI number is 1104, the TCP/IP 50, the IP Address 51, the Subnet Mask 52, the Gateway 53, the Netware 54 and the Apple talk 55), the monitoring period 60, the warning instruction 61, the modification permission 62, the notification instruction 63 and the comment 65, respectively. Further, the CPU 31 changes the content of the modification time section 42c to the current time. Then, control proceeds to S111.

Since the modification reservation data may be generated in S112 (which will be described later), the contents of the target modification history data before the modification are temporarily stored in the RAM 33 in S110, before modified.

In S111, the CPU 31 determines whether the target modification history data Is to be set to the previous data (i.e., to be recovered) based on the contents of the recovering instruction included in the parameter modification instruction received in S101. When the recovering is instructed (i.e., the content of the recovering instruction included in the parameter modification instruction is “YES”) (S111: YES), control proceeds to S112. When the recovering is not instructed (i.e., the content of the recovering instruction is “NO”) (S111: NO), control returns to S101, where the reception of the parameter modification instruction is monitored.

In S112, the CPU 31 generates modification reservation data and stores the same in the modification reservation database 43, and control proceeds to S113. It should be noted that the content of the UI number section 43a of the modification reservation data generated in S112 is set to the UI number before modified in S110. The contents of the IP Address section 43b, the reserved parameter section 43d, the warning instruction section 43f, the modification permission section 43g, the notification instruction section 43h and the comment section 43i of the modification reservation data are set to the contents of the IP Address section 42b, the reserved parameter section 43d, the warning instruction section 42f, the modification permission section 42g, the notification instruction section 42h and the comment section 42i before modified in S110, respectively. Further, the content of the reservation time section 43c of the modification reservation data is set to the time obtained by adding the monitoring period 60 included in the parameter modification instruction received in S101 to the current time (e.g., which represents the effective period). According to the embodiment, the procedure in accordance with the recovering instruction is executed when the previously set monitoring period expires. Therefore, the content of the monitoring period section 43e of the modification reservation data is 00:00.

It should be noted that, when the check box 68a is checked in the window shown in FIG. 3B, the value set In the input box 68b is stored in the Job recovery section 43j of the modification reservation database 43. Further, when the radio button 69a is selected, the IP address of the client, or the first user (i.e., one of the personal computers 2a through 2d) is stored in the setter section 43k. When the check box 68a is not checked, “No” is stored in the job recovery section 43j, and the “No” is stored also in the setter section 43k.

In S113, the CPU 31 determines whether the notification is instructed based on the content of the notification instruction section 43h before the modification is made in S110. When the notification is instructed (i.e., the content of the notification instruction section 43h before the modification is “YES”) (S113: YES), control proceeds to S114. When the notification is not instructed (i.e., the content of the notification instruction section 43h is “NO”) (S113: NO), control returns to S101 where the reception of the parameter modification instruction is monitored.

In S114, the printer 3 identifies an e-mail address of the user (i.e., the first user) who set the previous modification history data before the modification based on the user management database 41 and the IP Address of the IP Address section 42b before modified in S110, and transmits an e-mall message indicating that the modification history data is modified within the monitoring period (see FIG. 6) to the identified e-mail address. Thereafter, control returns to S101, where the reception of the parameter modification instruction is monitored. It should be noted that the user to whom the e-mail message transmitted in S114 is addressed can know that the parameters are modified within the monitoring period by opening the e-mail message.

When the CPU 31 determines that the modification is not allowed (S106: NO), the printer 3 transmits, under control of the CPU 31, the contents of the second warning message to the personal computer 2 which issued the parameter modification instruction received by the printer 3 in S101 (i.e. to the personal computer 2 of the second user). The personal computer 2 displays, under control of the CPU 31, the second warning message on the display unit 26 when the personal computer 2 receives the second warning message. Then, control proceeds to S116.

In S116, the CPU 31 determines what button among the “YES” button 82a, “NO” button 82b or the “RESERVE” button 82c is selected. When the “YES” button 82a is selected (S116: YES), control proceeds to S117. When the “NO” button 82b is selected (S116: NO), control returns to S101 and monitors the reception of the parameter modification instruction. When the “RESERVE” button 82c is selected (S116: RESERVED), control proceeds to S118. According to the embodiment, when the “YES” button 82a, “NO” button 82b or the “RESERVE” button 82c is selected, information regarding the selected button is transmitted from the personal computer 2 to the printer 3.

When it is judged the “YES” button 82a is selected (S116: YES), the printer 3 transmits, under control of the CPU 31, the contents of the modification permission request window (see FIG. 5B) and the e-mail address of the user who has set the current settings to the personal computer 2, which issued the parameter modification instruction received in S101. It should be noted that the user name (e.g., Tanaka, in the example of FIG. 5B) is determined based on the contents of the user management database 41 and the contents of the IP Address section 42b of the target modification history data. When the contents of the modification permission request window is received, the personal computer 2 displays, under control of the CPU 21, the modification permission request window on the display unit 26. Then, the user inputs the e-mail address in the address input box 83, and a request message in the message input box 84. Then, control returns to S101, where reception of the parameter modification instruction is monitored. The user who had set the current parameters can know that such a request was issued by opening the e-mail message.

When it is judged that the “RESERVE” button 82c is selected (S116: YES), control proceeds to S118 where the printer 3 transmits, under control of the CPU 31, the contents of the modification time reservation window (see FIG. 5C) to the personal computer 2 which issued the parameter modification instruction received in S101. When the contents of the modification time designation window are received, the personal computer displays, under control of the CPU 21, the modification time designation window on the display unit 26. Then, the user can input the time (hours or minutes) after which the operational parameters are modified using the pull-down menu of the period input box 86. After inputting the period, when the user selects the “OK” button 87a, the time (which represents the extended period) input in the period input box 86 is transmitted from the personal computer to the printer 3.

The CPU 31 of the printer 3 creates the modification reservation data, which is stored in the modification reservation database 43. Thereafter, control returns to S101, where the reception of the parameter modification instruction is monitored.

The contents of the UI number section 43a, the IP Address section 43b, the reserved parameter section 43d, the monitoring period section 43e, the warning instruction section 43f, the modification permission section 43g, the notification instruction section 43h and the comment section 43i of the modification reservation data created in S118 are set to the values of the UI number, the IP Address, the operational parameters (when the UI number is 1104, the TCP/IP 50, the IP Address 51, the Subnet Mask 52, the Gateway 53, the Netware 54, the Apple talk 55), the monitoring period 60, the warning instruction 61, the modification permission 62, the notification instruction 63 and the comment 65 included in the parameter modification instruction received in S101, respectively. Further, the content of the reservation time section 43c of the modification reservation data is set to the time obtained by adding the time period input in the period input box 86 (see FIG. 5C) to the current time.

In S119, the CPU 31 changes the contents of the IP Address section 42b, the setting parameter section 42d, the monitoring period section 42e, the warning instruction section 42f, the modification permission section 42g, the notification instruction section 42h and the comment section 42i of the target modification history data-stored in the modificator history database 42 to the set/modified contents of the IP Address, the operational parameters (when the UI number is 1104, the TCP/IP 50, the IP Address 51, the Subnet Mask 52, the Gateway 53 the Netware 54, the Apple talk 55), the monitoring period 60, the warning instruction 61, the modification permission 62, the notification instruction 63 and the comment 65 included in the parameter modification instruction received in S101, respectively. Further, the contents of the modification time section 42c is changed to the current time. Then, control proceeds to S120. Since there is a case where the modification reservation data is created in S121 (described later) before the modification, the contents of the target modification history data before the modification is temporarily stored in the RAM 33.

In S120, the CPU 31 determines whether the recovering instruction has been made (i.e., whether the target modification history data is set back to the previous data) based on the content of the recovering instruction included in the parameter modification instruction received in S101. When the recovering is instructed (i.e., the contents of the recovering instruction is “YES”) (S120: YES), control proceeds to S121. When the recovering is not instructed (i.e., the contents of the recovering instruction is “NO”) (S120: NO), control returns to S101, where the reception of the parameter modification instruction is monitored.

In S121, the CPU 31 creates the modification reservation data and stores the same in the modification reservation database 43. There after, control returns to S101, where the reception of the parameter modification instruction is monitored. The content of the UI number section 43a of the modification reservation data created in S121 is equal to the value of the UI number before modified in S119. Further, the contents of the IP Address section 43b, the reserved parameter section 43d, the warning instruction section 43f, the modification permission section 43g, the notification instruction section 43h and the comment section 43i of the modification reservation data are set to the contents of the IP Address section 42b, the setting parameter section 42d, the warning instruction section 42f, the modification permission section 42g, the notification instruction section 42h and the comment section 42i before modified in S120, respectively. Further, the content of the reservation time section 43c of the modification reservation data is set to the time obtained by adding the monitoring period 60 included in the parameter modification instruction received in S101 to the current time. Furthermore, the procedure according to the recovering instruction is executed when the previously set monitoring period expires, and therefore, the content of the monitoring period section 43e of the modification reservation data is 00:00. As in S112, when the check box 68a is checked in the window shown in FIG. 3B, the value set in the input box 68b is stored in the job recovery section 43j of the modification reservation database 43. Further, when the radio button 69a is selected, the IP address of the client, or the first user (i.e., one of the personal computers 2a through 2d) is stored in the setter section 43k. When the check box 68a is not checked, “No” is stored in the job recovery section 43j, and the “No” is stored also in the setter section 43k.

It should be noted that, when a user (i.e., the second user) who is requested for permission of the modification in S117 of FIG. 10 modifies the current parameter settings to the required ones (note that the modification history data can be made even in the monitoring period in this case: “YES” in S104), the user (i.e., the second user) who requested the modification of the parameter setting can use the printer 3 with the parameter setting as desired.

Alternatively, when the user who was allowed to modify the data in S117 modified the data (note that the modification history data can be made even in the monitoring period in this case: “YES” in S104), and thereafter, the user who requested for the modification of the parameter settings re-modified the parameter setting corresponding to his/her purpose, the latter user can use the printer 3 according to the desired parameter settings.

Next, a procedure shown in FIG. 11 will be described. FIG. 11 shows a flowchart illustrating a second modifying procedure executed in the network system 1 shown in FIG. 1.

In S201, the CPU 31 determines whether the modification reservation data is in the modification reservation database 43. When the modification reservation data is in the modification reservation database 43 (S201: YES), control proceeds to S202. When the modification reservation data is not stored in the modification reservation database 43 (S201: NO), control returns to S201.

In S202, the CPU 31 determines whether the current time is equal to the modification reservation time in the reservation time section 43c of the modification reservation data. When the current time is the reserved time (S202: YES), control proceeds to S203. When the current time is not yet the reserved time (S202: NO), control returns to S201.

In S203, the CPU 31 modifies the modification history data having the same UI number in the UI number section 42a as the UI number included in the modification reservation time section 43c, deletes the modification reservation data, then control returns to S201. By the modification in S203, contents of the IP Address section 42b, the setting parameter section 42d, the monitoring period section 42e, the warning instruction section 42f, the modification permission section 42g, the notification instruction section 42h and the comment section 42i of the modification history data created in S203 are set to the values of the IP Address section 43b, the reserved parameter section 43d, the monitoring period section 43e, the warning instruction section 43f, the modification permission section 43g, the notification instruction section 43h and the comment section 43i of the modification reservation data, respectively. Further, the content of the modification time section 42c is set to the time when the data is modified (i.e., the current time).

As described above, in S203, after the modification history data is updated, the modification reservation data is deleted. By deleting the modification reservation data, an unintended recovery of parameter settings can be avoided. For example, when the monitoring period has elapsed and the parameter settings are recovered, and when the user makes a further modification, there remains a possibility that the previous settings may recover as the printing jobs are executed if the modification reservation data remains undeleted. According to the embodiment described above, since the modification reservation data is deleted after the modification history data is updated, such a defect is avoidable.

Next, a comment displaying procedure will be described referring to FIG. 12. FIG. 12 shows a flowchart illustrating the comment displaying procedure executed by the personal computer 2 in the network system 1 shown in FIG. 1. The comment calling procedure is started, for example, when the operational parameter setting window is displayed in the personal computer 2 and the CPU 21 retrieves the comment displaying program from the ROM 22.

In S301, the CPU 21 determines when the comment button 56 as shown in FIG. 3A is selected by the user. When the comment button 56 is selected (S301: YES), control proceeds to S302. When the comment button 56 is not selected (S310: NO), control returns to S301.

In S302, the personal computer 2 requests the printer 3, under control of the CPU 21, for the comment corresponding to the UI number indicated in the operational parameter setting window currently displayed on the display unit 26 of the personal computer 2. In response to this request, the printer 3 retrieves the content of the comment section 42i from the modification history data corresponding to the requested UI number and stored in the modification history database 42, and transmits the same to the personal computer 2 requesting the comment. Then, the personal computer 2 displays the comment received from the printer 3 on the display unit 26.

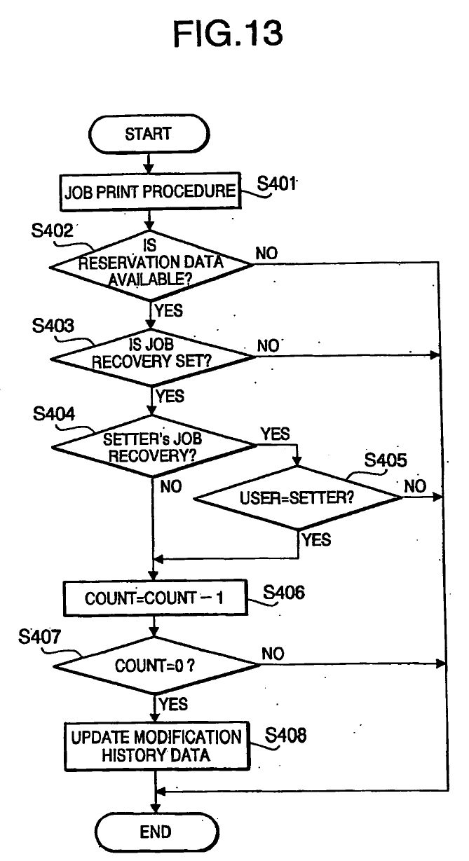

FIG. 13 is a flowchart illustrating a printing procedure executed for each printing job. The procedure shown in FIG. 13 is executed by the CPU 31 separately from the procedures shown in FIG. 10-12.

When a printing job is transmitted from a personal computer 2 to the printer 3, the CPU 31 start the procedure shown in FIG. 13. In S401, the CPU 31 executes a printing procedure which is a normal printing process corresponding to the received printing job. The, in S402, the CPU 31 determines whether the modification reservation data (see FIG. 9) which is generated in S112 or S121 of FIG. 10 exists. That is, it is determined whether the radio button 64a (see FIG. 3B) was selected so that the parameter settings are to be recovered to previous values when the monitoring period elapses (or the user-desired number of printing jobs have been executed).

When there is no modification reservation data (S402: No), the printing procedure of FIG. 13 is finished. When there is the modification reservation data (S402: YES), the CPU 31 further determines whether the job recovery setting is effective (S403). When the value set in the job recovery section 43j of the modification reservation data is equal to or greater than 1 (one) (S403: YES), control proceeds to S404. When the value of the Job recovery section 43j is “No” (S403: NO), the job recovery is not set. In this case, the procedure of FIG. 13 is finished.

In S404, the CPU 31 determines whether the setter's job recovery is set. When an IP Address is registered in the setter section 43k of the modification reservation data shown in FIG. 9, the setter's job recovery is set (S404: YES), and in this case, control proceeds to S405. When the value of the setter section 43k is “No”, the CPU 31 determines that the setter's job recovery is not set (S403: No). In this case, the procedure proceeds S406.

In S405, the CPU 31 determines whether the user who made the current parameter settings (i.e., the first user) and the user who transferred the print job (i.e., the second user) are the same by comparing the IP address stored in the setter section 43k of the modification reservation database 43 with the IP address of the computer 2 from which the current printing job has been transferred. When the first user is different from the second user (S405: No), the procedure of FIG. 13 is finished. When the first user and the second user are the same (S405: YES), control proceeds to S406.

In S406, the value stored in the job recovery section 43j of the modification reservation database 43 is decremented by one.

In S407, the CPU 31 determines whether the updated value of the job recovery section 43j is zero. When the value stored in the job recovery section 43j is not zero (S407: No), the procedure is finished since the number of the printing jobs is less than the user-set number of printing jobs to be executed. When the value stored in the job recovery section 43j becomes equal to zero (S407: YES), the parameter settings of the printer 3 is recovered to the settings stored in the modification reservation database 43, and the modification history data shown in FIG. 8 is updated (S408). In S408, after updating the modification history data, the modification reservation data is deleted, so that the unintentional recovery of the parameter settings is avoided.

It should be noted that the present invention n ed not be limited to the above-described configurations. Various modifications can be considered without departing from the scope of the invention. For example, In the above-described embodiment, the request for modifying the modification history data is monitored and modified by the printer 3 (see FIGS. 10 and 12). However, the invention need not be limited to such a configuration. A server may be provided in the network system 1, and the request for modification of the modification history data and modification of the same may be done by the server.

A parameter setting system having such a configuration will be described as a second embodiment of the invention.

According to the second embodiment, the structure of the parameter setting system is substantially similar to that shown in FIG. 1. In the second embodiment, however, a personal computer 2a (alternatively, a work station on the LAN 5) is provided with a Web server and a modification input program for modifying the parameter settings of the printer 3. The modification input program is a program running on the Web server of the personal computer 2a (or the workstation). Further, according to the second embodiment, each of the personal computers 2b-2d is provided with a Web browser. A user of each of the personal computers 2b-2d can access the Web server in the personal computer 2a using the Web browser and operate the modification input program remotely. Typically, the Web browsers communicate with the Web server using HTTP protocol, and the Web server communicates with the printer 3 using the SNMP protocol.

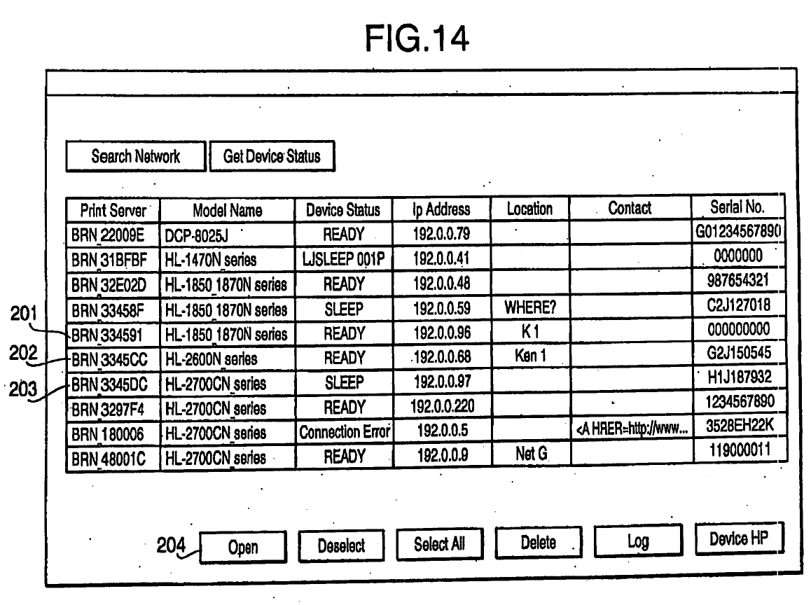

The modification input program running on the personal computer 2a periodically accesses the printer 3 and other printers on the LAN 5 and receives status information therefrom using the SNMP. FIG. 14 schematically shows a main window of the modification input program running on the personal computer 2a.

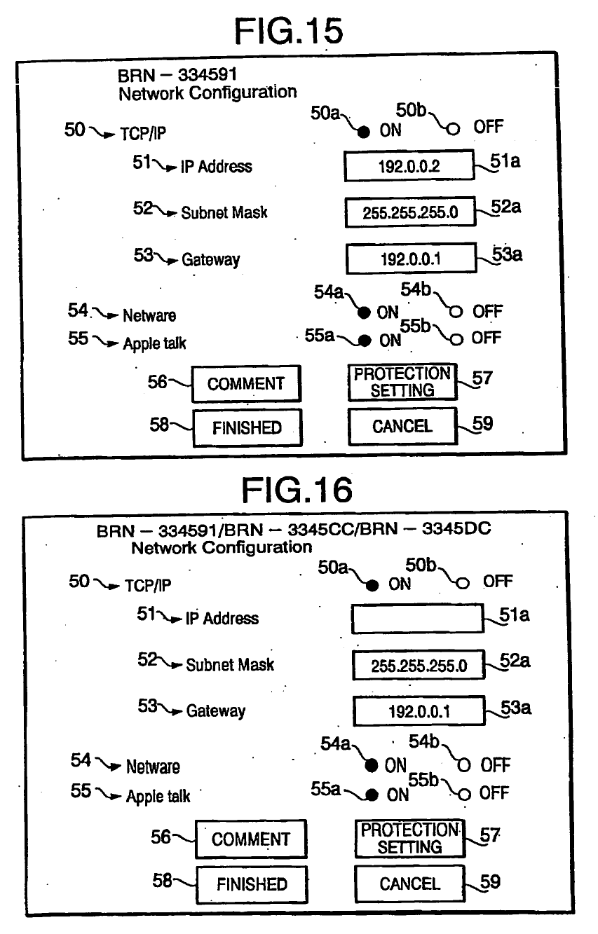

If the user selects a printer (BR_{—}334951) indicated by a reference number 201 in FIG. 14, and clicks an “Open” button 204, the modification input program transmits a request for the parameter settings thereof to the printer (i.e., BR_{—}334951). Then, the modification input program receives the SNMP reply from the printer (BR_{—}334951), and generates data for displaying a window as shown in FIG. 3A. Further, the received parameter settings are stored in the modification history data as shown in FIG. 8. In the second embodiment, the modification history data is also stored in the personal computer 2a. The thus generated data for displaying the window as shown in FIG. 3A is transmitted to the personal computers 2b-2d. As the window data is transmitted, in the Web browser running on each of the personal computers 2b-2d, a window shown in FIG. 15 is displayed.

It should be noted that the items shown in FIG. 15 are similar to those shown in FIG. 3A, therefore description thereof in FIG. 3A applies to the items shown in FIG. 15. According to the second embodiment, the modification history database 42 (shown in FIG. 8) and the modification reservation database 43 (shown in FIG. 9) are stored in the personal computer 2a. However, the functions of the databases 42 and 43 are similar to those in the first embodiment, and the description thereof will not be repeated.

It should also be noted that, the procedures described with reference to FIGS. 10-12 in the first embodiment, which are executed in the printer 3, are executed in the personal computer 2a in the second embodiment. Then, when the modification history data is updated, the parameter settings are transmitted from the personal computer 2a to the printer 3. In this case, the CPU 31 sets the parameter settings received from the personal computer 2a as the settings thereof. The procedure shown in FIG. 13 is not performed in the second embodiment.

According to the second embodiment, in the main window shown in FIG. 14, a plurality of printers can be selected. For example, by selecting printers 201-203 (i.e., BRN_{—}334591, BRN_{—}3345DC and BRN_{—}3345CC) and clicking the open button 204, the modification input program receives the parameter settings from each of the selected printers 201-203. When a plurality of printers are selected, the modification input program generates a parameter setting window as shown in FIG. 16, which are transmitted to the personal computers 2b-2d.

In the parameter setting window shown in FIG. 16, the names of the selected printers 201-203 (i.e.. BRN_{—}334591, BRN_{—}3345DC and BRN_{—}3345CC) are indicated at the top of the window. Since the IP addresses of the printers are different from each other, the input box 51a is made blank. Preferably, when a plurality of printers are selected, the item of IP Address including the input box 51a should be made gray out, or should not be displayed.

Even when a plurality of printers are selected, the procedures similar to those shown in FIGS. 10-12 are executed, and the modification history database and the modification reservation database are updated with respect to the selected printers. When the modification history database has been updated, the updated parameter settings are transmitted to each of the selected printers.

In FIGS. 3A, 15 and 16, the parameters relating to the communication protocol are set. However, the invention need not be limited to the protocol parameter settings, and various parameter settings can be modified. For example, usage of printing sheets and/or selection of sheet trays may be modified using the setting system according to the invention.

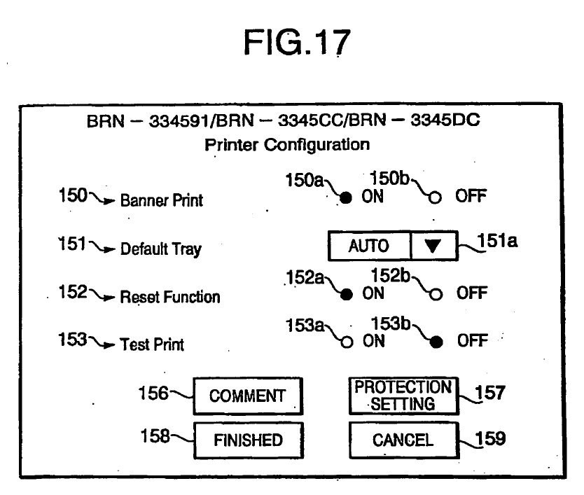

FIG. 17 is an exemplary parameter setting window with which the parameter settings related to the usage of the printer and usage/selection of the sheet can be modified. In this example, a banner print 150, a default tray 151, a reset function 152 and a test print function 153 can be set.

The banner print 150 is a function of outputting a sheet on which various printing information is printed in addition to the output according to the print job. This function is made effective when a radio button 150a is selected, and made ineffective when a radio button 150b Is selected.

The default tray 151 is a function of designating a sheet tray from among a plurality of trays the printer has to be used as a default tray when a specific designation of the sheet tray is not included in the print job. The default tray can be set by selecting one of the trays indicated in a pull down menu 151a. Optionally or alternatively, the menu 151a may be configured such that a type or a size of the sheet may be selected.

The reset function 152 is a function of allowing/preventing a reset of a soft reset of the printer, which is executed as an interruption procedure, when a soft-reset button of the printer is operated or such an instruction is transmitted from an external device (e.g., a personal computer). When a radio button 152a is selected, the soft reset of the printer is allowed, while when a radio button 152b is selected, the soft reset of the printer is prevented.

The test print function 153 is a function of allowing/preventing a test print of the printer, which is executed as an interruption procedure, when a test print button of the printer is operated or such an instruction is received from an external device (e.g., a personal computer). When a radio button 153a is selected, the test print of the printer is allowed, while when a radio button 153b is selected, the test print of the printer is prevented. Optionally, the above function may be employed in a factory default reset function.

A comment button 156, a protection setting button 157, a finished button 158 and a cancel button 159 are similar to the comment button 156, the protection setting button 57, the “Finished” button 58 and the “Cancel” button 59 shown in FIGS. 3A, 15 and 16, and description thereof is omitted.

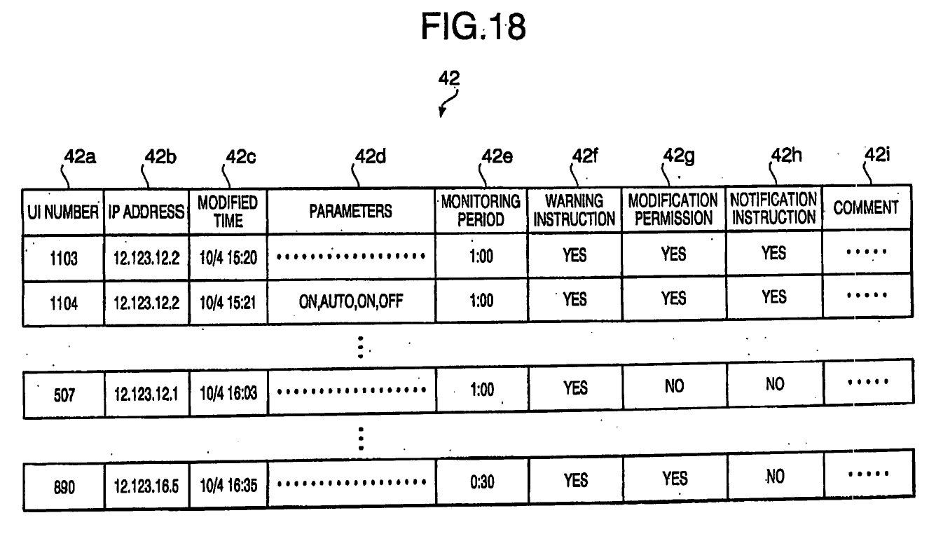

In accordance with the parameters to be set/modified shown in FIG. 17, the modification history database and the modification reservation database should also be modified. FIG. 18 shows an example of the modification history database corresponding to the parameter settings shown in FIG. 17. It should be noted that the parameters to be set may be various combinations of parameters shown in FIG. 3A (15, of 16) and shown in FIG. 17.

The setting system according to the first or second embodiment may be modified such that, when the modification of the parameters is requested during the monitoring period or before the user-desired number of printing jobs are executed, the request is merely rejected without displaying a message indicating the rejection.

Further, in the above-described embodiment, the monitoring period is set by the personal computer 2. However, it can be modified such that the monitoring period or the number of executions of the printing jobs can be set by operating the operation unit 35 of the printer 3. Alternatively, the monitoring period may be a fixed value stored in the printer 3.

Further, in the above-described embodiment, the printer 3 is referred to as an electronic device. It should be noted that any other electronic device such as a scanner, a facsimile machine, a multifunction peripheral and the like can be employed as the electronic device instead of or in addition to the printer 3.

The procedures described above can be stored, as programs to be executed by the personal computer, in computer-accessible recording medium such as a CD-ROM. Alternatively or optionally, such programs can be distributed through a network such as the Internet.

With the network system according to the invention, when a user (i.e., the second user) who is different from the user (i.e., the first user) who set the current modification history data attempts to modify the same, modification is rejected. Therefore, the modification history data is prevented from being modified during the monitoring period. Further, in this case, the user (i.e., the second user) who attempts to modify the modification history data is notified of the status (i.e., during the monitoring period) with messages (i.e., the first warning message, and the second warning message).

Further, when the modification history data is modified during the monitoring period, it is notified to the user (i.e., the first user) who set the previous modification history data (the data before the modification). Accordingly, the user (i.e., the first user) can deal with this matter appropriately. For example, the user (i.e., the first user) may wait until the other user (i.e., the second user) finishes using the printer.

Furthermore, the user (i.e., the second user), who requested for the modification of the modification history data during the monitoring period, requests the user (i.e., the first user) who set the current modification history data for permission to modify the data. Therefore, the user (i.e., the second user) requesting for the permission to modify can modify the data in a relatively earlier stage, and can use the printer 3 with the desired settings.

The modification history data can be modified only for a period the user intends, and after the expiration of the period (effective period), the parameters can be set to the previously set values. Therefore, the printer can be shared among a plurality of users flexibly. In particular, when the request for modifying the modification history data is issued during the monitoring period, a time when the modification history data is modified can be reserved, which improves the usage flexibility of the shared printer.

The present disclosure relates to the subject matter contained in Japanese Patent Application No. 2002-341115, filed on Nov. 25, 2002. which is expressly incorporated herein by reference in its entirety.

What is claimed is:

1. A network system having a plurality of terminal devices and an electronic device whose function is shared by said plurality of terminal device, said plurality of terminal devices and said electronic device being communicatively connected through a network, operational parameters of said electronic device being set by users of said plurality of terminal devices through the network, said network system comprising:
a monitoring period determining system that determines a monitoring period with respect to operational parameters set by a first user;
a monitoring system that monitors whether a request for modification of the operational parameters issued by a second user is received during the monitoring period; and
a modification control system that modifies the operational parameters in accordance with the request for modification if the monitoring system determines that the request for the modification is received after expiration of the monitoring period, said modification control system executing at least one of rejecting the request by the second user and outputting a message corresponding to the request by the second user if said monitoring system determines that the request for modification is received during the monitoring period.

2. The network system according to claim 1, wherein the monitoring period is defined as a time period after the operational parameters are set by the first user.

3. The network system according to claim 1, wherein said monitoring period setting system includes a time period inputting system, the monitoring period being determined based on the time period input through said time period inputting system.

4. The network system according to claim 1, wherein an end of the monitoring period is defined as a point of time.

5. The network system according to claim 1, wherein said monitoring period setting system includes a time inputting system, an end of the monitoring period being determined based on the point of time which is input through said time inputting system.

6. The network system according to claim 1, wherein the message output by the modification control system is a message, which is transmitted to the second user, indicating that a current time is within the monitoring period.

7. The network system according to claim 1, wherein the message output by the modification control system is a message, which is transmitted to the first user, informing that the operational parameters have been modified by the second user within the monitoring period.

8. The network system according to claim 1, further including a permission requesting system that requests the first user for permission to modify the operational parameters.

9. The network system according to claim 1, further including:
an effective period determining system that determines whether an effective period designated by the terminal device has expired; and
a recovering system that sets the operational parameters to previously set values after expiration of the effective period.

10. The network system according to claim 1, further comprising a postponed period checking system that checks whether a postponed period for postponing the modification of the operational parameters has expired, the postponed period being instructed by the terminal device, said modification controlling system enabling the modification f the operational parameters after expiration of the postponed period.

11. The network system according to claim 1, further including a setting management device which is connected with said terminal device and a plurality of electronic devices through the network, said setting management device being provided with a setting input system that is used to input modification settings of the operational parameters for said plurality of electronic device, the modification settings input through said setting input system being set in said plurality of electronic devices.

12. The network system according to claim 11, wherein one of said plurality of terminal devices includes said setting management device.

13. The network system according to claim 11, wherein said setting management device includes an electronic device electronic devices as a target device whose operational parameters are to be modified, the modification settings input through said setting input system being effected as the modification settings of said at least one of the electronic device selected by said electronic device selecting system.

14. The network system according to claim 1,
wherein said terminal device includes an instruction system that transmits instructions to the electronic device using a predetermined communication protocol; and
wherein said electronic device includes a job executing system that executes a job which is instructed by said instruction system and transmitted from said terminal device using the predetermined communication protocol,
the operational parameters including a parameter to be used when said electronic device communicates with said terminal device using the predetermined communication protocol.

15. The network system according to claim 1, wherein said electronic device includes a printing system, the operational parameters including a parameter related to an output format when said electronic device prints a print job with said printing system.

16. The network system according to claim 15, wherein the parameter related to the output format includes a parameter related to a banner print.

17. The network system according to claim 1, wherein said electronic device includes a printing system, the operational parameters including a parameter related to a sheet supply when said electronic device executes a print Job with said printing system.

18. The network system according to claim 17, wherein said printing system is capable of using a plurality of types of sheets for printing, the parameter related to the sheet supply including a default type of a sheet to be used.

19. The network system according to claim 17, wherein said printing system includes a plurality of sheet trays containing sheets to be used for printing, the parameter related to the sheet supply including a default tray to be used.

20. The network system according to claim 1, wherein said electronic device includes an interruption procedure execution system that executes an interruption procedure when a predetermined Job is executed, the operational parameters including a parameter that enables/disables execution of the interruption procedure during the predetermined job.

21. A network system having a plurality of terminal devices and an electronic device whose function is shared by said plurality of terminal device, said plurality of terminal devices and said electronic device being communicatively connected through a network, operational parameters of said electronic device being set by users of said plurality of terminal devices through the network, said network system comprising:
a number of execution determining system that determines the number of times of operations to be executed by said electronic device in accordance with operational parameters set by a first user;
a monitoring system that monitors whether the number of executed operations of said electronic device exceeds the number of times determined by said number of execution determining system when a request for modification of the operational parameters issued by a second user is received; and
a modification control system that modifies the operational parameters in accordance with the request for modification if monitoring system determines that the number of executed operations of said electronic device exceeds the number of times determined by said number of execution determining system, said modification control system executing at least one of rejecting the request by the second user and outputting a message corresponding to the request by the second user if said monitoring system determines that the number of executed operations of said electronic device is equal to or less than the number of times determined by said number of execution determining system.

22. The network system according to claim 21,
wherein said terminal device includes a instruction system that instructs said electronic device to execute a job;
wherein said electronic device includes a job executing system that executes the job instructed by said terminal device, said number of execution determining system determining the number of executions of the job to be executed by said job executing system.

23. The network system according to claim 21, wherein the message output by the modification control system is a message, which is transmitted to the second user, indicating that the number of executed operations of said electronic device is equal to or less than the number of times determined by said number of execution determining system.

24. The network system according to claim 21, wherein the message output by the modification control system is a message, which is transmitted to the first user, informing that the operational parameters have been modified by the second user before the number of executed operations of said electronic device exceeds the number of times determined by said number of execution determining system.

25. The network system according to claim 21, further including a permission requesting system that requests the first user for permission to modify the operational parameters.

26. The network system according to claim 21, further including:
an effective period determining system that determines whether an effective period designated by the terminal device has expired; and
a recovering system that sets the operational parameters to previously set values after expiration of the effective period.

27. The network system according to claim 21, further comprising a postponed period checking system that checks whether a postponed period for postponing the modification of the operational parameters has expired, the postponed period being instructed by the terminal device, said modification controlling system enabling the modification of the operational parameters after expiration of the postponed period.

28. The network system according to claim 21, further including a setting management device which is connected with said terminal device and a plurality of electronic devices through the network, said setting management device being provided with a setting input system that is used to input modification settings of the operational parameters for said plurality of electronic device, the modification settings input through said setting input system being set In said plurality of electronic devices.

29. The network system according to claim 28, wherein one of said plurality of terminal devices includes said setting management device.

30. The network system according to claim 28, wherein said setting management device includes an electronic device selecting system that selects at least one of the plurality of electronic devices as a target device whose operational parameters are to be modified, the modification settings input through said setting input system being effected as the modification settings for said at least one of the electronic device selected by said electronic device selecting system.

31. The network system according to claim 21,
wherein said terminal device includes an instruction system that transmits instructions to the electronic device using a predetermined communication protocol: and
wherein said electronic device includes a job executing system that executes a job which is instructed by said instruction system and transmitted from said terminal device using the predetermined communication protocol,
the operational parameters including a parameter to be used when said electronic device communicates with said terminal device using the predetermined communication protocol.

32. The network system according to claim 21, wherein said electronic device includes a printing system, the operational parameters including a parameter related to an output format when said electronic device executes a print job with said printing system.

33. The network system according to claim 32, wherein the parameter related to the output format includes a parameter related to a banner print.

34. The network system according to claim 21, wherein said electronic device includes a printing system, the operational parameters including a parameter related to a sheet supply when said electronic device prints a print job with said printing system.

35. The network system according to claim 34, wherein said printing system is capable of using a plurality of types of sheets for printing, the parameter related to the sheet supply including a default type of a sheet to be used.

36. The network system according to claim 34, wherein said printing system includes a plurality of sheet trays containing sheets to be used for printing, the parameter related to the sheet supply including a default tray to be used.

37. The network system according to claim 21, wherein said electronic device includes an interruption procedure execution system that executes an interruption procedure when a predetermined job is executed, the operational parameters including a parameter that enables/disables execution of the interruption procedure during the predetermined job.

38. A network system having a plurality of terminal devices and an electronic device whose function is shared by said plurality of terminal device, said plurality of terminal devices and said electronic device being communicatively connected through a network, operational parameters of said electronic device being set by said plurality of terminal devices through the network, said network system comprising:
a modifying system that modifies the operational parameters in accordance with a request for modification of the operational parameters requested by a terminal device;
a message storing system that stores a message input by a user of the terminal device with which the operational parameters are modified in relationship with modified operational parameters; and
a message outputting system that outputs the message stored In relationship with the modified operational parameters by said message storing system in response to an output command of a message corresponding to the modified operational parameters.

39. An electronic device for a network system having a plurality of terminal devices, a function of said electronic device being shared by the plurality of terminal device, the plurality of terminal devices and said electronic device being communicatively connected through a network, operational parameters of said electronic device being set by users of the plurality of terminal devices through the network, said electronic device comprising:
a monitoring time determining system that determines a monitoring time with respect operational parameters set by a first user;
a monitoring system that monitors whether a request for modification of the operational parameters issued by a second user is received during the monitoring period; and
a modification control system that modifies the operational parameters in accordance with the request for modification if said monitoring system determines that the request for the modification is received after expiration of the monitoring period, said modification control system executing at least one of rejecting the request by the second user and outputting a message corresponding to the request by the second user if said monitoring system determines that the request for modification is received during the monitoring period.

40. An electronic device for a network system having a plurality of terminal devices, a function of said electronic device being shared by the plurality of terminal device, the plurality of terminal devices and said electronic device being communicatively connected through a network, operational parameters of said electronic device being set by users of the plurality of terminal devices through the network, said electronic device comprising:
a number of execution determining system that determines the number of times of operations to be executed by said electronic device in accordance with operational parameters set by a first user;
a monitoring system that monitors whether the number of executed operations of said electronic device exceeds the number of times determined by said number of execution determining system when a request for modification of the operational parameters issued by a second user is received; and
a modification control system that modifies the operational parameters in accordance with the request for modification if monitoring system determines that the number of executed operations of said electronic device exceeds the number of times determined by said number of execution determining system, said modification control system executing at least one of rejecting the request by the second user and outputting a message corresponding to the request by the second user if said monitoring system determines that the number of executed operations of said electronic device is equal to or less than the number of times determined by said number of execution determining system.

41. An electronic device for a network system having a plurality of terminal devices, a function of said electronic device being shared by the plurality of terminal device, the plurality of terminal devices and said electronic device being communicatively connected through a network, operational parameters of said electronic device being set by the plurality of terminal devices through the network, said electronic device comprising:
a modifying system that modifies the operational parameters in accordance with a request ferm dification of the operational parameters requested by a terminal device;
a message storing system that stores a message input by a user of the terminal device, with which the operational parameters are modified, in relationship with the modified operational parameters; and
a message outputting system that outputs the message stored in relationship with the modified operational parameters by said message storing system in response to an output command of a message corresponding to the modified operational parameters.

42. A computer program product which controls a computer to function as an electronic device for a network system having a plurality of terminal devices, a function of said electronic device being shared by the plurality of terminal device, the plurality of terminal devices and said electronic device being communicatively connected through a network, operational parameters of said electronic device being set by users of the plurality of terminal devices through the network, the computer program product controlling the computer to have functions of:
a monitoring time determining system that determines a monitoring time with respect operational parameters set by a first user;
a monitoring system that monitors whether a request for modification of the op rational parameters issued by a second user is received during the monitoring period; and
a modification control system that modifies the operational parameters in accordance with the request for modification if said monitoring system determines that the request for the modification is received after expiration of the monitoring period, said modification control system executing at least one of rejecting the request by the second user and outputting a message corresponding to the request by the second user if said monitoring system determines that the request for modification is received during the monitoring period.

43. A computer program product which controls a computer to function as an electronic device for a network system having a plurality of terminal devices, a function of said electronic device being shared by the plurality of terminal device, the plurality of terminal devices and said electronic device being communicatively connected through a network, operational parameters of said electronic device being set by users of the plurality of terminal devices through the network, the computer program product controlling the computer to have functions of:
a number of execution determining system that determines the number of times of operations to be executed by said electronic device in accordance with operational parameters set by a first user;
a monitoring system that monitors whether the number of executed operations of said electronic device exceeds the number of times determined by said number of execution determining system when a request for modification of the operational parameters issued by a second user is received; and
a modification control system that modifies the operational parameters in accordance with the request for modification if monitoring system determines that the number of executed operations of said electronic device exceeds the number of times determined by said number of execution determining system, said modification control system executing at least one of rejecting the request by the second user and outputting a message corresponding to the request by the second user if said monitoring system determines that the number of executed operations of said electronic device is equal to or less than the number of times determined by said number of execution determining system.

44. A computer program product that controls a computer to function as an electronic device for a network system having a plurality of terminal devices, a function of said electronic device being shared by the plurality of terminal device, the plurality of terminal devices and said electronic device being communicatively connected through a network, operational parameters of said electronic device being set by the plurality of terminal devices through the network, the computer program product controlling the computer to have functions of:
a modifying system that modifies the operational parameters in accordance with a request for modification of the operational parameters requested by a terminal device;
a message storing system that stores a message input by a user of the terminal device, with which the operational parameters are modified, in relationship with the modified operational parameters; and
a message outputting system that outputs the message stored in relationship with the modified operational parameters by said message storing system in response to an output command of a message corresponding to the modified operational parameters.

45. A network system having a plurality of terminal devices and an electronic device whose function is shared by said plurality of terminal device, said plurality of terminal devices and said electronic device being communicatively connected through a network, operational parameters of said electronic device being set by users of said plurality of terminal devices through the network, said network system comprising:
a monitoring condition determining system that determines a monitoring condition with respect operational parameters set by a first user;
a monitoring system that monitors whether a request for modification of the operational parameters received from a second user meets the monitoring condition; and
a modification control system that modifies the operational parameters in accordance with the request for modification if the monitoring system determines that the request for the modification meets the monitoring condition, said modification control system executes a predetermined operation If said monitoring system determines that the request for modification does not meet the monitoring condition
